(19) United States
(12) Patent Application Publication
(10) Pub. No.: US 2012/0173345 A1
(43) Pub. Date: Jul. 5, 2012

(54) Unified Tracking and Reporting Across Multiple Publishers

(75) Inventors: John D. Yanefski, Seattle, WA (US); Chandrasekhar Pasupuleti, Redmond, WA (US); William Lawson Sterling Claudill, Seattle, WA (US)

(73) Assignee: MICROSOFT CORPORATION, Redmond, WA (US)

(21) Appl. No.: 12/982,421

(22) Filed: Dec. 30, 2010

(51) Int. Cl. G06Q 30/00

(52) U.S. Cl. 705/14.73

(57) ABSTRACT

Methods and system for collecting and disambiguating data across multiple, disparate publishers using a tracking uniform resource locator (URL) are provided. A tracking URL is created that maps a keyword or advertisement with a landing page. The tracking URL comprises a compound key and publisher specific formatting strings. A user selection corresponding to the tracking URL is received. The tracking URL along with fact data corresponding to the user selection is logged into a fact record. Further, the landing page associated with the tracking URL is retrieved and presented to the user.

### BACKGROUND

Advertisers are interested in tracking how well their Internet advertising campaigns are working across multiple, disparate publishers. However, advertisers are typically presented with data concerning a particular advertisement campaign from one publisher at a time, and, moreover, this data is often ambiguous with respect to the exact advertisement or keyword that drove a user engagement. As a result, advertisers have to comb through multiple reports and try to extract, interpret, and compile data that is useful for judging the efficacy of the advertising campaign.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to computer implemented systems and methods for collecting and reporting data across multiple, disparate publishers. A tracking uniform resource locator (URL) is generated that maps a keyword or advertisement with a landing page. The tracking URL replaces a publisher's destination URL for the keyword or advertisement. When a user selects an advertisement or keyword corresponding to the tracking URL, the user selection is received by a redirect service that logs the tracking URL and other attributes of the user selection as a fact record. The landing page that corresponds to the tracking URL is then retrieved and presented to the user. The tracking URL can also be used to join publisher dimensional data and fact data associated with the advertisement or keyword with the fact record logged by the redirect service. The dimensional data and fact data can then be compared to the fact record logged by the redirect service to provide an advertiser with a unified, side-by-side view of important business data.

### BRIEF DESCRIPTION OF THE DRAWINGS

The present invention is described in detail below with reference to the attached drawing figures, wherein:

FIG. 1 is a block diagram of an exemplary system suitable for collecting data from multiple, disparate publishers, in accordance with an embodiment of the present invention;

FIG. 2 is a flow diagram showing a method for disambiguating data across multiple, disparate publishers, in accordance with an embodiment of the present invention;

FIG. 3 is a flow diagram showing a method for collecting data from multiple, disparate publishers, in accordance with an embodiment of the present invention; and

FIG. 4 is a block diagram of an exemplary computing environment suitable for use in implementing embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein provide for collecting and reporting data across multiple, disparate publishers. Advertisers often judge the efficacy of an Internet advertising campaign by monitoring keyword and advertisement performance. Typically the advertising campaign is run across multiple publishers. Hence, advertisers want a way compile data on keyword and advertisement performance across these multiple, disparate publishers. As well, advertisers want a way to compare this data to the data supplied by the individual publishers, not only to verify that they are being billed correctly, but also to get a comprehensive picture of how well, for example, an advertising campaign is performing with respect to a particular publisher.

Accordingly, in one embodiment, the present invention is directed to a system, including at least one processor and at least one computer-readable storage medium storing a plurality of components, comprising a tracking uniform resource locator (URL) generating component, a receiving component, a logging component, a landing page retrieval component, an identifying component, a pseudo-key generating component, and a presentation component. The tracking URL generating component generates a tracking URL that maps a keyword or advertisement with a landing page and comprises a compound key and publisher specific formatting strings. The receiving component receives a user selection corresponding to the tracking URL. As well, the logging component logs the tracking URL along with fact data associated with the user selection into a fact record. The landing page retrieval component retrieves the landing page associated with the tracking URL, while the presentation component presents the landing page to the user. In addition, the identifying component identifies advertisements or keywords associated with the tracking URL where the advertisements or keywords and their associated dimensional data and fact data are obtained from a publisher. As well, the identifying component matches the dimensional data and fact data for the advertisement or keyword with the fact record associated with the same tracking URL. Finally, the pseudo-key generating component generates a pseudo-keyword that maps an advertisement to its parent advertisement group.

In another embodiment, the present invention is directed to one or more computer-readable storage media having computer-executable instructions embodied thereon, that when executed, cause a computing device to perform a method for reporting and tracking user selection data across multiple, disparate publishers. The method includes accessing dimensional data and fact data associated with an advertisement or keyword from a publisher. A tracking URL is identified for each advertisement or keyword retrieved from the publisher. The tracking URL comprises a compound key and publisher specific formatting strings and maps a keyword or advertisement with a landing page. The method further includes sorting the dimensional data and fact data into at least one of search account dimensions, keyword facts, or advertisement facts. External selection data for the tracking URL is received, and the external selection data and data from at least one of the search account dimensions, keyword facts, or advertisement facts is presented to the user in a unified report.

In yet another embodiment, the present invention is directed to one or more computer-storage media having computer-executable instructions embodied thereon, that when executed, cause a computing device to perform a method for collecting information across multiple, disparate search and content networks. The method includes creating a tracking URL that maps a keyword or advertisement with a landing page. The tracking URL comprises at least one of an OwnerID key, a ROIEntityID key, or a ROIVariantID key. Further, the method includes storing the mapping between the keyword or advertisement and the landing page in a data store. Next, a user selection corresponding to the tracking URL is received, and the tracking URL is logged into a fact record along with fact data corresponding to the user selection. In one aspect, the type of fact data that is logged into the fact record is configurable to an advertiser's specifications. Continuing, the landing page associated with the tracking URL is retrieved from the data store, and the landing page is presented to the user.

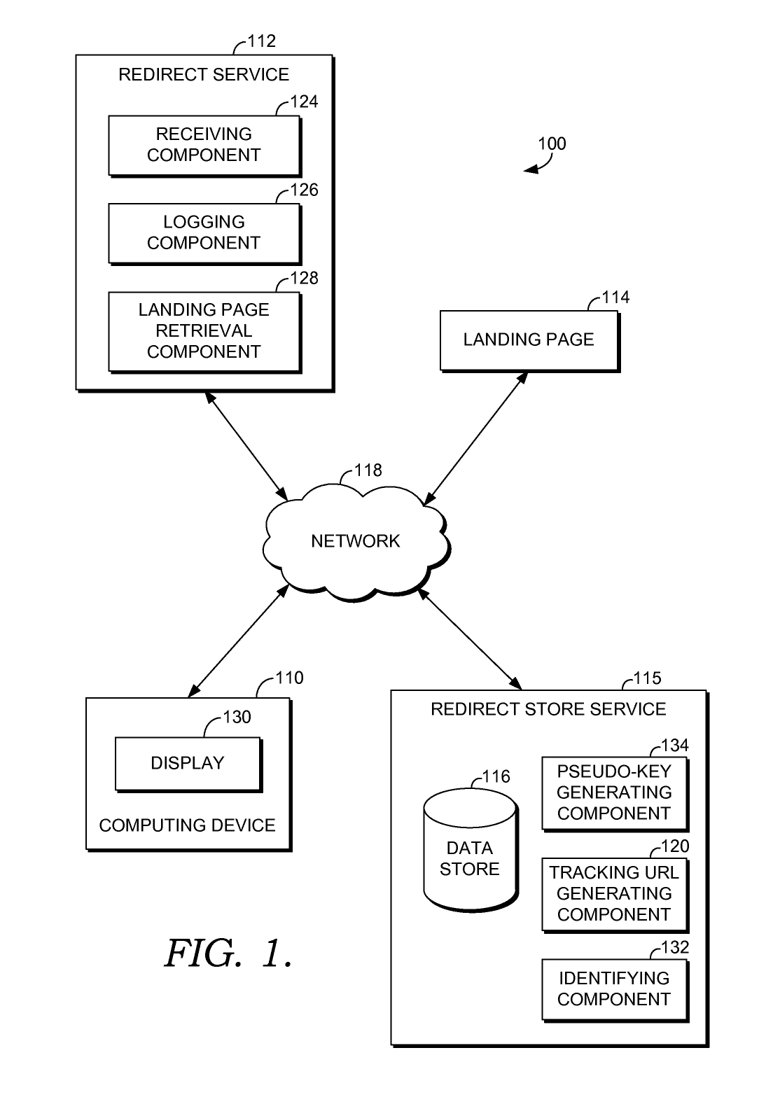

Turning now to FIG. 1, a block diagram is illustrated that shows an exemplary computing system environment 100 suitable for use in implementing embodiments of the present invention. It will be understood and appreciated by those of ordinary skill in the art that the computing system environment 100 shown in FIG. 1 is merely an example of one suitable computing system environment and is not intended to suggest any limitation as to the scope of use or functionality of embodiments of the present invention. Neither should the computing system environment 100 be interpreted as having any dependency or requirement related to any single module/component or combination of modules/components illustrated therein.

The computing system environment 100 includes a computing device 110, a redirect service 112, a landing page 114, and a redirect store service 115 all in communication with one another via a network 118. The network 118 may include, without limitation, one or more local area networks (LANs) and/or wide area networks (WANs). Such networking environments are commonplace in offices, enterprise-wide computer networks, intranets and the Internet. Accordingly, the network 118 is not further described herein.

In some embodiments, one or more of the illustrated components/modules may be implemented as stand-alone applications. In other embodiments, one or more of the illustrated components/modules may be integrated directly into the operating system of the redirect service 112, the redirect store service 115, and/or the end-user computing device 110. It will be understood by those of ordinary skill in the art that the components/modules illustrated in FIG. 1 are exemplary in nature and in number and should not be construed as limiting. Any number of components/modules may be employed to achieve the desired functionality within the scope of embodiments hereof. Further, components/modules may be located on any number of servers or advertiser computing devices. By way of example only, the redirect service 112 and the redirect store service 115 might reside on a server, cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

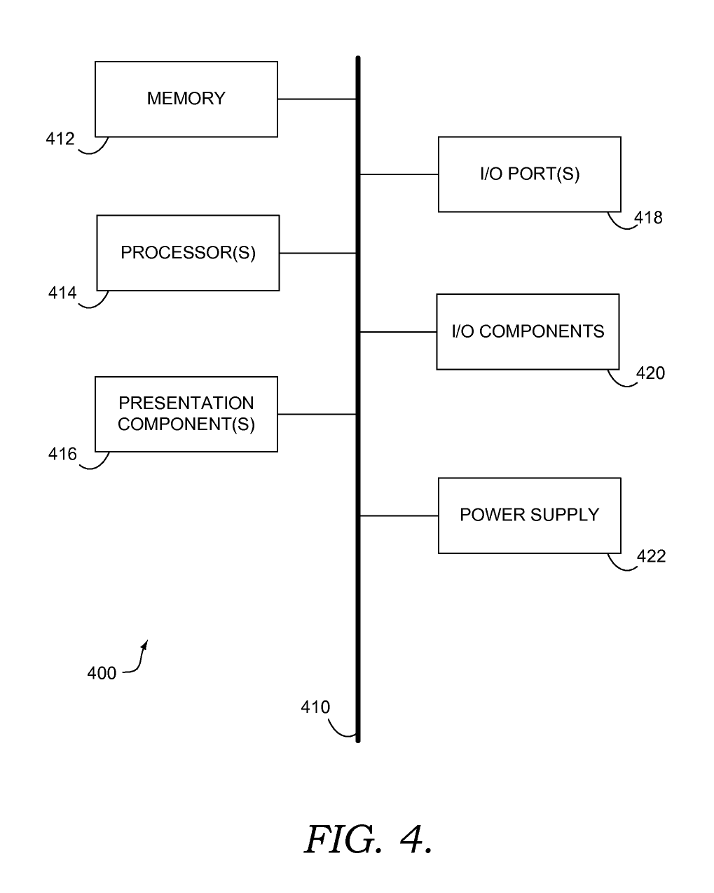

Each of the computing device 110, the redirect service 112, and the redirect store service 115 shown in FIG. 1 may be any type of computing device, such as, for example, computing device 400 described below with reference to FIG. 4. By way of example only and not limitation, each of the computing device 110, the redirect service 112, and the redirect store service 115 may be a personal computer, desktop computer, laptop computer, handheld device, mobile handset, consumer electronic device, or the like. It should be noted, however, that embodiments are not limited to implementation on such computing devices, but may be implemented on any of a variety of different types of computing devices within the scope of embodiments hereof.

Components of the computing device 110, the redirect service 112, and the redirect store service 115 may include, without limitation, a processing unit, internal system memory, and a suitable system bus for coupling various system components, including one or more databases for storing information (e.g., files and metadata associated therewith). Each of the computing device 110, the redirect service 112, and the redirect store service 115 typically includes, or has access to, a variety of computer-readable media. By way of example, and not limitation, computer-readable media may include computer-storage media and communication media. In general, communication media enables each computing device to exchange data via a network, e.g., network 118. More specifically, communication media may embody computer-readable instructions, data structures, program modules, or other data in a modulated data signal, such as a carrier wave or other transport mechanism, and may include any information-delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

It will be understood by those of ordinary skill in the art that computing system environment 100 is merely exemplary. While the redirect service 112, and the redirect store service 115 are illustrated as a single unit, one skilled in the art will appreciate that the redirect service 112 and the redirect store service 115 are scalable. For example, the redirect service 112 and the redirect store service 115 may in actuality include a plurality of computing devices in communication with one another. Moreover, the data store 116, or portions thereof, may be included within, for instance, the redirect service 112, and/or the computing device 110 as a computer-storage medium. The single unit depictions are meant for clarity, not to limit the scope of embodiments in any form.

As shown, the end-user computing device 110 includes a display screen 130. The display screen 130 is configured to display information to the user of the computing device 110, for instance, information relevant to communications initiated by and/or received by the computing device 110, landing pages, reports, and the like. Embodiments are not intended to be limited to visual display but rather may also include audio presentation, combined audio/visual presentation, and the like.

As shown in FIG. 1, the redirect service 112 comprises a receiving component 124, a logging component 126, and a landing page retrieval component 128. In turn, the redirect store service 115 comprises a data store 116, a tracking URL generating component 120, an identifying component 132, and a pseudo-key generator 134. In some embodiments, one or more of the components 120, 124, 126, 128, 132, and 134 may be implemented as stand-alone applications. In other embodiments, one or more of the components 120, 124, 126, 128, 132, and 134 may be integrated directly into the operating system of the computing device 110. It will be understood by those of ordinary skill in the art that the components 120, 124, 126, 128, 132, and 134 illustrated in FIG. 1 are exemplary in nature and in number and should not be construed as limiting. Any number of components may be employed to achieve the desired functionality within the scope of embodiments hereof.

The tracking URL generating component 120 is configured to generate a tracking URL that maps a keyword or advertisement with a landing page 114. In one aspect, the tracking URL generating component 120 generates a different tracking URL for each keyword or advertisement associated with a particular advertising campaign. As well, one or more landing pages 114 may be mapped to a single keyword or advertisement. The tracking URL does not contain the actual landing page URL. This allows an advertiser to alter a landing pages 114 associated with the advertisement or keyword without the need for the tracking URL generating component 120 to generate a new tracking URL. This aspect, in one example, supports changing or rotating landing pages associated with the same keyword or advertisement. In another aspect, the system 100 may comprise a storing component (not shown) configured to store mappings between keywords or advertisements and the landing page 114 in the data store 116.

The tracking URL comprises a compound key and publisher specific formatting strings. The compound key has one or more keys that together uniquely identify one or more landing pages for a keyword or advertisement. The compound key is de-coupled from the publisher's website which allows it to be used with any number of publishers. By way of example and not limitation, publishers may include search engines such as YAHOO!®, GOOGLE®, BING®, and the like, as well as other applications such as, for example, TWITTER®, and FACEBOOK®.

In one embodiment of the technology, the compound key comprises an OwnerID key and a ROIEntityID key. The OwnerID key may be a unique advertiser ID associated with a particular publisher account and assigned by the redirect store service 115. In one aspect, the OwnerID key defines the default landing page in the event the tracking URL is corrupted. This is useful to get a user of the publishing site to the advertiser's website. Continuing, the ROIEntityID key comprises a parameter that defines an advertisement or keyword. It is unique within the context of the OwnerID key and may be generated by the redirect service 112 or, in one example, by an outside developer, where an outside developer may comprise an outside advertising agency. In yet another embodiment, the compound key comprises an OwnerID key, a ROIEntityID key, and a ROIVariantID key. The ROIVariantID key further attributes the ROIEntityID key and will be discussed in more depth below. The OwnerID key, the ROIEntityID key, and the ROIVariantID key may, in one aspect, be provided by the advertiser, generated by the redirect service 112, provided by an outside developer, or extracted from the publisher. Any and all such variations, and any combination thereof, are contemplated to be within the scope of embodiments of the present invention.

A substitution component (not shown) may be configured to substitute a publisher destination URL associated with the keyword or advertisement with the tracking URL. The destination URL is a URL required by a publisher to link an advertiser's keywords or advertisements with the advertiser's website. In general terms, it is the page that users see when they click through to the advertiser's website from a keyword or advertisement. In another embodiment of the invention, an advertiser manually replaces the publisher destination URL with the tracking URL for each advertisement or keyword.

Continuing, the receiving component 124 is configured to receive a user selection corresponding to the tracking URL that has been substituted for a destination URL. By way of example, a user may visit a publisher's website and enter a keyword search query. After the publisher returns the results of the query, the user may select (or otherwise engage with) an advertisement, where the advertisement has been mapped to a landing page by the tracking URL. This selection/engagement may then be received by the receiving component 124. Further, the logging component 126 is configured to log the tracking URL as well as fact data corresponding to the user selection into a fact record. In one aspect, the logging component 126 may be configurable to an advertiser's specifications. Thus, the advertiser can specify the type of fact data in which they are interested.

As mentioned above, the type of fact data that is logged may be tailored to an individual advertiser, but in general terms may include search-specific data as well as general data. General data may include such things as the ID of the redirect service 112, the website of the redirect service 112, the advertiser ID, the Internet protocol address, the time of a user engagement (e.g., selection or click) and the nature of the engagement, a cookie, a tentative cookie, or the like. Likewise, search-specific data may include such data as whether or not the engagement is a search selection, the referring domain, the referring search term, the landing page URL, or the like. The fact data logged by the logging component 126 into the fact record may, in embodiments, be made available to an analytics engine (not shown). The analytics engine may also receive data concerning user activity with respect to the landing page associated with the advertisement or keyword. In yet another aspect, the analytics engine may make this data available to a downstream reporting system. Any and all such variations, and any combination thereof, are contemplated to be within the scope of embodiments of the present invention.

Continuing on with respect to FIG. 1, the landing page retrieval component 128 is configured to retrieve the landing page 114 corresponding to the tracking URL. In one embodiment, the landing page retrieval component 128 retrieves the landing page 114 from the data store 116 associated with the system 100. In yet another embodiment, if the landing page retrieval component 128 cannot find the landing page 114 corresponding to the advertisement or keyword, a default landing page 114 will be set at the OwnerID key level so as to direct the user to the advertiser's website. In turn, if more than one landing page 114 corresponds to the advertisement or keyword, the landing pages 114 may be weighted equally and one landing page 114 randomly selected. This simulates a round-robin approach when enough user selections are received for a particular advertisement or keyword; this also provides the advertiser with the ability to test whether one landing page 114 is more profitable than another landing page 114. Any and all such variations, and any combination thereof, are contemplated to be within the scope of embodiments of the present invention.

The presentation component, corresponding generally to display component 130, is configured to present the landing page 114 to the user. In one aspect, parameters in a query string associated with the landing page 114 that are not recognized by the presentation component (display component 130) may be appended to the end of the landing page URL. For example, an advertiser may have a custom id on the landing page URL that the advertiser wants for its own purposes. This custom id parameter is not recognized by the presentation component (display component 130) and is appended to the end of the landing page URL. The user is then presented with the landing page 114. Alternatively, parameters in the query string associated with the landing page 114 that are recognized by the presentation component (display component 130) and desired by the advertiser may be configured to pass through unchanged. Additionally, parameters in the query string associated with the landing page 114 that are recognized by the presentation component but not desired by the advertiser may be removed before presenting the landing page 114 to the user. Any and all such variations, and any combination thereof, are contemplated to be within the scope of embodiments of the present invention.

The identifying component 132 identifies advertisements or keywords with a tracking URL where the advertisement or keywords and the associated dimensional data and fact data are obtained, received, or extracted from a publisher. As well, the identifying component matches the dimensional data and fact data for the advertisement or keyword with the fact record associated with the same tracking URL. To reiterate, the tracking URL identified for the advertisement or keyword obtained from the publisher is the same tracking URL used by the redirect service 112 to map the advertisement or keyword with a landing page. The identifying component 132 links the dimensional data and fact data for the advertisement or keyword obtained from the publisher with the fact record logged by the redirect service 112 for that same advertisement or keyword. Further with respect to FIG. 1, pseudo-key generating component generates a pseudo-keyword that is associated with an advertisement group. This process will be explained in more depth below.

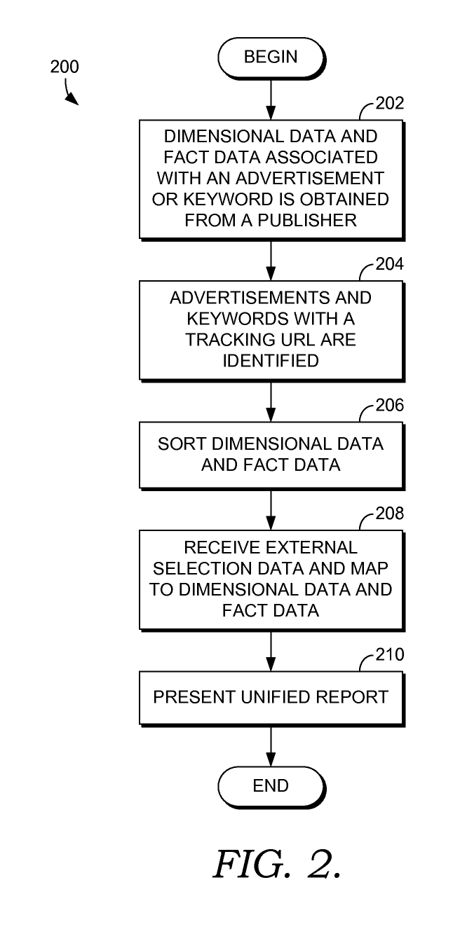

With reference to FIG. 2, a flow diagram is illustrated showing a method 200 for tracking and reporting data across multiple, disparate publishers to provide uniform reporting, in accordance with an embodiment of the present invention. As shown in block 202, dimensional and fact data associated with an ad or keyword is obtained from a publisher. At block 204, the advertisements or keywords with a tracking URL are identified. This is useful because, in one aspect, the dimensional data and fact data obtained from the publisher may include advertisements and keywords that do not have a tracking URL. At block 206, the dimensional data and the fact data for the advertisement or keyword are sorted into at least one of search account dimensions, keyword dimensions, or advertisement facts. Search account dimensions may comprise data regarding advertising campaigns, advertisements, and advertisement groups used in the campaign. In turn, keyword dimensions may comprise data about keywords used in an advertising campaign, while advertisement facts may comprise reports regarding advertisement impressions, user selections (e.g., clicks), and cost. Click through rate, average cost per click, total cost, and average cost per impression are derived from the aforementioned fact data. In turn, revenue generated and click conversions are available by joining redirect service fact records with external data sources. For example, external data sources may include data about events that occur at an advertiser's landing page such as conversion rates, and the amount of revenue associated with the conversion. This data is available to be combined with redirect service fact records to yield additional advertisement facts. In one embodiment, search account dimensions, keyword facts, or advertisement facts may be associated with one or more data stores.

Continuing on with respect to FIG. 2, at block 208 external selection data for the tracking URL is received. In one embodiment, the external selection data comprises fact data associated with the tracking URL and logged by the logging component 126 into a fact record. To emphasize this point, the tracking URL associated with the external selection data corresponds to the same tracking URL identified for the dimensional data and fact data for the advertisement or keyword obtained from the publisher. At block 210, the external selection data and the data from at least one of search account dimensions, keyword facts, or advertisement facts are presented to an advertiser in a unified report. The ability to present the advertiser with a side-by-side view of the external selection data and the data obtained from the publisher for the same tracking URL benefits the advertiser by allowing independent validation of publisher fact data that is the basis of the publisher's means for billing the advertiser. The method outlined above is applicable to any number of publishers or third parties who track this type of advertising information. As well, data obtained from multiple publishers for the same advertisement or keyword can be unified into one report.

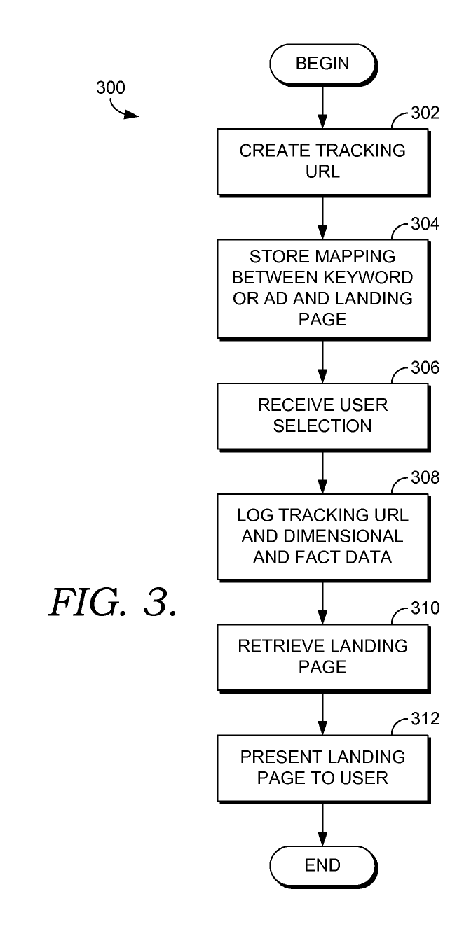

With reference to FIG. 3, a flow diagram is illustrated showing a method 300 for collecting information across multiple, disparate search and content networks in accordance with an embodiment of the present invention. In general, a search network may be defined as a network that delivers advertisements when a user searches in a search engine by a keyword and relevant advertisements are displayed. Thus, the advertisement delivered is based on the keyword search performed. Likewise, a content network may be defined as a network that delivers advertisements when a user visits a webpage. In this scenario, no search is involved and the advertisement is chosen based on the content of the webpage.

As shown at block 302, a tracking uniform resource locator (URL) is created that maps a keyword or advertisement with a landing page. The tracking URL comprises at least one of an OwnerID key, a ROIEntityID key, or a VariantID key. At block 304, the mapping between the keyword or advertisement and the landing page is stored in a data store (e.g., data store 116 of FIG. 1). Continuing, at block 306, a user selection corresponding to the tracking URL is received. At block 308, the tracking URL and the fact data corresponding to the user selection are logged into a fact record. The type of fact data logged is configurable to an advertiser's specifications. Further, at block 310, the landing page associated with the tracking URL is retrieved from the data store, and at block 312, the landing page is presented to the user.

By way of illustrative example, and not by limitation, the generation of a tracking URL for an advertisement or keyword on MICROSOFT ADCENTER® (AdCenter) is provided. In general, AdCenter supports only one destination URL per keyword or advertisement. The destination URL is served whenever a keyword or advertisement is clicked in either a search network or a content network. The redirect service 112, however, allows for more than one landing page per keyword. This is accomplished by using an OwnerID key, and a ROIEntityID key, and, further, by using a ROIVariantID key to further attribute the ROIEntityID key.

As discussed above, the OwnerID key comprises an ID associated with a particular search or content network. As an example, the OwnerID key may be {44589}. Also, as mentioned above, the ROIEntityID key comprises a parameter that defines a specific advertisement or keyword. For example, the ROIEntityID key may be {hiking shoe} where “hiking shoe” defines a specific keyword. By adding a ROIVariantID key, additional attributes may be added to ROIEntityID{hiking shoe}. In one embodiment, the keyword “hiking shoe” may be further attributed by the type of bidding on that keyword, where the type of bidding may comprise broad (b), exact (e), phrase (p), or content (c). Thus, a possible compound key may be OwnerID{44589}&ROIEntityID{hiking shoe}&ROIVariantID{b}. As can be seen, for example, up to four different compound keys may be constructed from the OwnerID key, the ROIEntityID key, and the ROIVariantID key, allowing for up to four different landing pages for the same keyword. But the ROIVariantID key is not limited to these four parameters. In fact, it can include any parameter (up to five characters) that the advertiser desires. In addition, it should be understood that different keys may be added to the compound key as necessary to further attribute the compound key allowing, in embodiments, more than four landing pages to correspond to a single keyword. Finally, the logging component 126 is configured to interpret and log tracking URLs containing ROIVariantID keys of (b), (e), and (p) as user selections corresponding to a search network, while tracking URLs containing the ROIVariantID key of (c) are logged as user selections corresponding to a content network.

An illustrative example of generating a pseudo-keyword for GOGGLE® (Google) is provided. Google advertisements delivered on a search network will automatically trigger the destination URL of the keyword that drove the advertisement. However, on a content network, no single keyword can be referenced as the “sole” reason for the advertisement being displayed. Instead, the advertisement is displayed based upon the advertisement group to which it belongs. An advertisement group may be defined as a group that has one or more advertisements which target one or more keywords. This presents two problems. First, the redirect service 112 cannot log fact data for any particular keyword associated with the advertisement. Second, it is difficult to identify which advertisement group the advertisement originated from when dimensional data and fact data for the advertisement is obtained from Google. To help solve this problem, in one aspect of the invention, a pseudo-keyword is generated (by, for example, pseudo-key generating component 134) that maps the advertisement to its appropriate parent advertisement group. Thus, when dimensional data and fact data is obtained from Google, the pseudo-keyword helps to determine which advertisement group the advertisement originated from. This ability to track which advertisement group the advertisement originated from allows advertisers to more accurately monitor their advertisement campaigns.

Continuing on with the Google example, Google allows four different destination URLs for one keyword based on whether keyword bidding is broad (b), exact (e), phrase (p), or content (c). Thus, it is not necessary for the ROIVariantID key to further attribute the ROIEntityID key, so the ROIVariantID key may be set to {0}. However, in embodiments, the ROIVariantID key may still be used to further differentiate the compound key based on, for example, what type of device the user selection originated from, or what type of application (e.g., FACEBOOK®) the user selection originated from.

Additionally, in embodiments, tags may be inserted into a tracking URL to validate whether a proper tracking URL has been constructed for a content network or for a search network. By way of illustrative example, the tag {if Content:c} may be inserted into the tracking URL with a ROIEntityID key of {advertisement}, and the tag {if Search:s} may be inserted into the tracking URL with a ROIEntityID key of {keyword}. Thus, an improper tracking URL occurs if a user selection in a content network returns a tracking URL of ROIEntityID{advertisement}&{if Search:s} Likewise, an improper tracking URL occurs if a user selection in a search network returns a tracking URL of ROIEntityID{keyword} & {if Content:c}.

Another illustrative example, this one based upon using YAHOO!® (Yahoo), is provided. Yahoo is structured similar to Google in that user selections of advertisements in a content network are not linked to individual keywords within the advertisement, but to the advertisement itself. Thus, a pseudo-keyword may be utilized as outlined above. A ROIVariantID key is generally not needed because the landing page can be defined on the basis of the OwnerID key and the ROIEntityID key. But, in embodiments, the ROIVariantID key may be used to designate different landing pages. By way of illustrative example, and not limitation, a user selection in a search network may be attributed either a (std) parameter or an (adv) parameter depending on the advertiser's preference of scope for that keyword. Likewise, a user selection in a content network may be attributed a {cnt} parameter. Thus, the ROIVariantID key may be set as either ROIVariantID{std}, or ROIVariantID {adv} for a tracking URL used in a search network, while the ROIVariantID may be set as ROIVariantID{cnt} for a tracking URL used in a content network. In embodiments, this use of the ROIVariantID key would allow for separate landing pages for the same keyword in a search network. In other embodiments, the use of the {std}, {adv}, or {cnt} parameters may act to validate whether a proper tracking URL has been generated as outlined above in the Google example.

### Exemplary Operating Environment

A first exemplary operating environment in which various aspects of the present invention may be implemented is described below in order to provide a general context for various aspects of the present invention. Referring to FIG. 4 in particular, an exemplary operating environment for implementing embodiments of the present invention is shown and designated generally as computing device 400. The computing device 400 is but one example of a suitable computing environment and is not intended to suggest any limitation as to the scope of use or functionality of the invention. Neither should the computing device 400 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network.

With continued reference to FIG. 4, the computing device 400 includes a bus 410 that directly or indirectly couples the following devices: memory 412, one or more processors 414, one or more presentation components 416, input/output ports 418, input/output components 420, and an illustrative power supply 422. The bus 410 represents what may be one or more busses (such as an address bus, data bus, or combination thereof). Although the various blocks of FIG. 4 are shown with lines for the sake of clarity, in reality, delineating various components is not so clear, and metaphorically, the lines would more accurately be grey and fuzzy. For example, one may consider a presentation component such as a display device to be an I/O component. Additionally, many processors have memory. The inventors hereof recognize that such is the nature of the art, and reiterate that the diagram of FIG. 4 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 4 and reference to “computing device.”

The computing device 400 typically includes a variety of computer-readable media. Computer-readable media can be any available media that can be accessed by computing device 400 and includes both volatile and nonvolatile media, removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 400. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 412 includes computer-storage media in the form of volatile and/or nonvolatile memory. The memory may be removable, non-removable, or a combination thereof. Exemplary hardware devices include solid-state memory, hard drives, optical-disc drives, etc. Computing device 400 includes one or more processors that read data from various entities such as memory 412 or I/O components 420. Presentation component(s) 416 present data indications to a user or other device. Exemplary presentation components include a display device, speaker, printing component, vibrating component, etc.

The I/O ports 418 allow computing device 400 to be logically coupled to other devices including the I/O components 420, some of which may be built in. Illustrative components include a microphone, joystick, game pad, satellite dish, scanner, printer, wireless device, etc.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term server is often used herein, it will be recognized that this term may also encompass an advertiser, a set of one or more processes distributed on one or more computers, one or more stand-alone storage devices, a set of one or more other devices, a combination of one or more of the above, and the like.

### CONCLUSION

As can be seen, embodiments of the present invention provide systems, methods, and computer-readable media for, among other things, collecting and disambiguating dimensional data and fact data across multiple, disparate publishers by using a unique tracking URL that maps a particular keyword or advertisement with a landing page. The use of the tracking URL provides advertisers with more granular data than that provided by the publishers, and allows this data to be compared to data extracted directly from the publishers.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

It will be understood by those of ordinary skill in the art that the order of steps shown in the method 200 of FIG. 2 and the method 300 of FIG. 3 are not meant to limit the scope of the present invention in any way and, in fact, the steps may occur in a variety of different sequences within embodiments hereof. Any and all such variations, and any combination thereof, are contemplated to be within the scope of embodiments of the present invention.

The present invention has been described in relation to particular embodiments, which are intended in all respects to be illustrative rather than restrictive. Alternative embodiments will become apparent to those of ordinary skill in the art to which the present invention pertains without departing from its scope.

The invention claimed is:

1. Computer-readable storage media having embodied thereon computer-useable instructions that, when executed, implement a system for collecting information across multiple, disparate publishers, the system comprising:
a tracking uniform resource locator (URL) generating component that generates a tracking URL that maps a keyword or advertisement with a landing page, wherein the tracking URL comprises a compound key and publisher specific formatting strings;
a receiving component that receives a user selection corresponding to the tracking URL;
a logging component that logs the tracking URL and fact data corresponding to the user selection into a fact record;
a landing page retrieval component that retrieves the landing page based on the tracking URL; and
a presentation component that presents the landing page to the user.

2. The computer-readable storage media of claim 1, wherein the system further comprises a storing component that stores the mapping between the keyword or advertisement and the landing page in a data store, and further wherein the landing page retrieval component retrieves the landing page from the data store.

3. The computer-readable storage media of claim 1, wherein a different tracking URL is generated for each keyword or advertisement.

4. The computer-readable storage media of claim 1, wherein one or more landing pages may be mapped to a keyword or an advertisement.

5. The computer-readable storage media of claim 4, wherein if more than one landing page is retrieved for the tracking URL, the landing pages are weighted equally and one landing page is randomly selected.

6. The computer-readable storage media of claim 1, wherein the compound key comprises at least an OwnerID and a ROIEntityID.

7. The computer-readable storage media of claim 6, wherein the OwnerID defines the default landing page in the event the tracking URL is corrupted.

8. The computer-readable storage media of claim 7, wherein the OwnerID comprises an ID associated with a particular publisher.

9. The computer-readable storage media of claim 8, wherein the ROIEntityID comprises a parameter that defines a specific advertisement or keyword.

10. The computer-readable storage media of claim 1, wherein parameters in the tracking URL that are not recognized by the presentation component are appended to the end of the tracking URL.

11. The computer-readable storage media of claim 1, wherein parameters in the tracking URL that are recognized by the presentation component but are not part of the tracking URL are configured to pass through unchanged.

12. The computer-readable storage media of claim 1, wherein the publisher comprises at least one of a search network or a content network.

13. The computer-readable storage media of claim 12, wherein a pseudo-keyword maps an advertisement to its appropriate parent advertisement group in the content network.

14. Computer-readable storage media having embodied thereon computer-useable instructions that, when executed, implement a method for collecting and reporting data across multiple, disparate publishers to provide uniform reporting, the method comprising:
obtaining dimensional data and fact data associated with an advertisement or keyword from a publisher;
identifying advertisements and keywords that have a tracking URL, wherein the tracking URL comprises a compound key and publisher specific formatting strings;
sorting the dimensional data and fact data into at least one of search account dimensions, keyword facts, or advertisement facts;
receiving external selection data for the tracking url; and
presenting the external selection data and the data from at least one of search account dimensions, keyword facts, or advertisement facts in a unified report.

15. The computer-readable storage media of claim 14, wherein the external selection data comprises fact data associated with a user selection from the publisher corresponding to the tracking URL.

16. The computer-readable storage media of claim 14, wherein the compound key can be used across multiple publishers.

17. The computer-readable storage media of claim 14, wherein the tracking URL comprises at least an OwnerID, a ROIEntityID, and a ROIVariantID.

18. The computer-readable storage media of claim 17, wherein the OwnerID, the ROIEntityID, and the ROIVariantID may be provided by an advertiser, generated by the system, or extracted from the destination URL.

19. The computer-readable storage media of claim 17, wherein the ROIVariantID further attributes the ROIEntityID and comprises at least one of the following parameters: broad (b), exact (e), phrase (p), or content (c).

20. Computer-readable storage media having embodied thereon computer-useable instructions that, when executed, implement a method for collecting information across multiple, disparate search and content networks, the method comprising:
creating a tracking uniform resource locator (URL) that maps a keyword or advertisement with a landing page, wherein the tracking URL comprises at least one of an OwnerID, a ROIEntityID, or a ROIVariantID;
storing the mapping between the keyword or advertisement and the landing page in a data store;
receiving a user selection corresponding to the tracking URL;
logging the tracking URL, and fact data corresponding to the user selection into a fact record, wherein the fact data logged is configurable to an advertiser;
retrieving the landing page associated with the tracking URL from the data store; and
presenting the landing page to the user.
